(19) United States
(12) Patent Application Publication
(10) Pub. No.: US 2026/0219150 A1
(43) Pub. Date: Jul. 30, 2026

(54) INSOLUBLE SUBSTANCE MEASUREMENT SYSTEM AND INSOLUBLE SUBSTANCE CONTENT MEASUREMENT METHOD

(71) Applicant: PetroChina Company Limited, Beijing (CN)

(72) Inventors: Dejun Shi, Beijing (CN); Shengbao He, Beijing (CN); Fei Chen, Beijing (CN); Chunyan Wang, Beijing (CN); Hongyue Yu, Beijing (CN); Xiaoyan Yang, Beijing (CN); Da Huo, Beijing (CN); Lina He, Beijing (CN); Huifeng Xue, Beijing (CN); Kebin Chi, Beijing (CN)

(21) Appl. No.: 19/141,691

(22) PCT Filed: Aug. 23, 2023
(86) PCT No.: PCT/CN2023/114469

§ 371 Date: Jun. 20, 2025

(30) Foreign Application Priority Data
Dec. 27, 2022 (CN) 202211680491.X

(51) Int. Cl. G01N 5/04; G01N 1/34; G01N 1/40

(52) U.S. Cl. CPC G01N 5/04; G01N 1/34; G01N 1/4022; G01N 2001/4027

(57) ABSTRACT

An insoluble substance measurement system and an insoluble substance content measurement method are disclosed. The system comprises a box body, and a leaching system, a sample injection system, and a separation system that are located in the box body; the leaching system comprises a first leaching bottle and a second leaching bottle; the sample injection system comprises at least one sample injection tube; the separation system comprises at least one separation column; the outlet of the first leaching bottle is connection with the sample injection tube, and the outlet of the first leaching bottle is further connection with the opening of the upper end of the separation column; the sample injection pipe is connection with the opening of the upper end of the separation column; and the outlet of the second leaching bottle is connection with the opening of the upper end of the separation column.

The present application claims priority to Chinese patent application No. 202211680491.X, entitled “INSOLUBLE SUBSTANCE MEASUREMENT SYSTEM AND INSOLUBLE SUBSTANCE CONTENT MEASUREMENT METHOD”, filed with the Chinese Patent Office on Dec. 27, 2022, the entire contents of which are incorporated herein by reference.

### FIELD OF TECHNOLOGY

The disclosure relates to an insoluble substance measurement system and a method for measuring an insoluble substance content, and belongs to the technical field of chemical analysis.

### BACKGROUND OF ART

Any substance has a certain solubility in a given solution, and a so-called “insoluble substance” means that the solubility in a given solvent is extremely low and approximately insoluble. In the international standard classification, the method for measuring insoluble substances involves inorganic chemistry, insecticides and other agrichemical products, non-ferrous metals, fertilizers, analytical chemistry, photographic technology, railway vehicles, ferrous metals, coating ingredients, spices and seasonings, food additives, coal, leather technology, petroleum product synthesis, construction materials, power plant synthesis, sugars, sugar products, starches, paraffins, asphalt materials and other petroleum products, lubricants, industrial oils and related products, crude oil, feed, metal material tests, water quality, chemical products, organic chemistry, etc. The insoluble substance content reflects some characteristics of compounds, such as water-insoluble impurities contained in solid salt layers and brine in salt minerals, also known as insoluble residues, of which the main components are sand, clay, carbonates of calcium and magnesium, organic residues and the like, and which is a main technical index for evaluating the quality of soluble salt minerals such as edible salt, potassium salt and trona and classifying the grade of ores. Insoluble substances will be accumulated in the lubricating oil during use due to abrasion and the like, and these insoluble substances can be classified into toluene insoluble and pentane insoluble. The pentane insoluble refer to insoluble substances separated by dissolving a lubricating oil in n-pentane. The pentane insoluble is mainly composed of dust, metal particles, soot, oxidation products of engine oil and the like, and the content thereof can reflect the use performance of the lubricating oil. The process of reagent production, storage and transportation will produce insoluble particles composed of inorganic particles such as calcium and silicon, or carbon black, fiber, bacteria, mold, spores and crystals, glass chips, and plastic particles and rubber particles. The entry of these insoluble particles into blood vessels may cause blockage of the blood vessels, granuloma, phlebitis, and thrombosis, and also damage myocardium and other organs (such as liver and kidney).

At present, there are more than 100 international standards, national standards, and industry standards for measuring insoluble substances in various chemical products, but these measurement methods generally involves the use of glass sand core funnels (such as GB/T 2441.6-2010 “Determination Method of Urea-Part 6: Weight Method of Water Insoluble Substance Content”, GB/T 19138-2003 “Determination Method of Pesticide Acetone Insoluble Substances”), filter membranes (ASTM D4055-04 (2009) “Standard Test Method for Pentane Insolubles by Membrane Filtration”), filter sieves (ASTM D4746-2014 “Determination of Quinoline Insolubles in Tar and Pitch by Pressurized Filtration”), filter papers (GB/T 2559.7-2005 “Determination Method of Benzene Insolubles in Lignite Wax”), and the like to measure insoluble substances by solvent extraction. Also, in these methods, insoluble impurities usually block the filter holes, causing blockage of the filter element and the like, thereby reducing the extraction efficiency; or the solvent is prone to reduce the quality of materials such as filter paper, resulting in large experimental errors. There are also reports on the determination of insoluble substances by centrifugation (GB/T 5822.2-2004 “Test Method of Petroleum Ether Insolubles in Lubricating Oil for Railway Locomotive Diesel Engine” and GB/T 8926-2012 “Standard Test Method for Insolubles in Used Lubricating Oils”), but there are also problems such as complicated steps, long time consumption and large amount of solvent used in the elution process.

Some prior art situations related to the disclosure will be briefly introduced below, and the disadvantages of the prior art will be analyzed and illustrated.

Chinese patent CN 109596451A discloses a method for detecting insoluble substances in ethylene propylene rubber comprising the following steps: s1, weighing ethylene propylene rubber, and dissolving the ethylene propylene rubber in 150N base oil; and S2, filtering the mixture by using a filter screen with the filtering precision of 1-75 μm, observing the filter screen by an electron microscope and a photographic method in an enlarged manner, checking whether insoluble substances exist or not, and testing the content of the insoluble substances by using a weighing weight-reducing method if the insoluble substances exist. The pretreatment process of the method is complicated, and it is based on toluene extraction of insoluble substances on the filter screen and has problems such as long-time consumption.

Chinese patent CN203909023U discloses a methylbenzene and quinoline insoluble measuring device which comprises a box body, a methylbenzene insoluble measuring instrument, a quinoline insoluble measuring instrument and a control device for controlling the methylbenzene insoluble measuring instrument and the quinoline insoluble measuring instrument. The device can detect methylbenzene and quinoline insoluble together and eliminates the damage of toxic gases to a human body, so that the device is convenient to operate. The methylbenzene insoluble measuring instrument can count accurately, and is high in measuring precision and good in data reproducibility. The quinoline insoluble measuring instrument can automatically measure a quinoline insoluble sample and ensure that the experimental process satisfies related standard requirements, so that errors caused by manual operation are avoided. However, the device and the method using the device are also based on the traditional Soxhlet extraction method, and has problems such as large amount of solvent, long time consumption, and low separation efficiency.

Chinese patent CN 111678833A discloses a method for measuring the content of water insoluble substances in sodium carbonate by using a microporous filter membrane, which comprises the following steps: (1) allowing the filter membrane to have a constant weight; (2) weighing 20 g of sodium carbonate sample with an accuracy to 0.01 g, placing the sodium carbonate sample in a beaker, adding 200 ml of water with the temperature of about 40° C., and maintaining the temperature of the experimental solution at 50+/−5° C.; placing the filter membrane having a constant weight on a solvent filter, connecting a vacuum pump to start filtering a sample; putting the filter membrane and the insoluble substances into a high-type weighing bottle with a corresponding number, and drying the filter membrane and the insoluble substances in an oven at 50+/−5° C. to constant weight; weighing a high-type weighing bottle by using an analytical balance, and recording the mass value of the high-type weighing bottle; (3) calculating the measurement result of the sample. The method is simple, convenient and quick to operate and high in accuracy, since the microporous filter membrane is used to measure water insoluble substances in sodium carbonate without pretreatment, and the sample is directly measured. However, this method still has problems of insoluble substances blocking the micropores of the filter membrane, low separation efficiency, poor elution effect, large amount of solvent, and the like.

Chinese patent CN 106947515A discloses a method for solid phase extraction separation of different types of compounds in crude oil or heavy oil, comprising: adding a crude oil or heavy oil sample into a stationary phase, washing the stationary phase with C5-C7 saturated hydrocarbon, extracting saturated hydrocarbon components in the sample, washing the stationary phase with chlorinated alkane, extracting aromatic hydrocarbon components in the sample, and washing the stationary phase with dichloromethane-ethanol mixture or ethanol to obtain a colloid, wherein the stationary phase comprises a water-soluble salt of a Group IB element or a Group iron element supported in alumina, wherein the content of the water-soluble salt of the Group IB element or the iron-group element is 2.0-10.0 mass % based on alumina. This method can effectively separate saturated hydrocarbons and aromatic hydrocarbons in crude oil or heavy oil samples, and each component obtained after separation can be directly used for instrument analysis, thereby obtaining the group compositions of the analysis samples. However, the amount of the sample treated by this method is only 0.4 g, and when the amount of the sample is increased, there is a problem that insoluble substances in the oil sample block the filter holes of the sieve plate, such that the analysis cannot be continued. Moreover, this method can only obtain the mass of soluble samples such as saturated hydrocarbons, aromatic hydrocarbons, gums and the like, and cannot directly obtain the content of insoluble substances. Finally, this method generally employs polar fillers, with irreversible adsorption for some strongly polar substances.

Therefore, it has become an urgent technical problem to be solved in this field to provide a novel insoluble substance measurement system and a method for measuring an insoluble substance content.

### SUMMARY OF INVENTION

In order to solve the above-mentioned disadvantages and shortcomings, one object of the disclosure is to provide an insoluble substance measurement system.

Another object of the disclosure is to provide a method for measuring an insoluble substance content.

In order to achieve the above objects, in one aspect, the disclosure provides an insoluble substance measurement system, comprising:
a box body, and a leaching system, a sample injection system, a separation system, an analysis system and a control system that are located in the box body, wherein the leaching system comprises a first leaching bottle and a second leaching bottle; the sample injection system comprises at least one sample injection tube, a heating device and an oscillation device; and the separation system comprises at least one separation column;
wherein an outlet of the first leaching bottle is in pipeline connection with the sample injection tube via a first control pump, and an outlet of the first leaching bottle is further in pipeline connection with an upper opening of the separation column via a first valve, a second valve and a third valve in sequence; the sample injection tube is in pipeline connection with the upper opening of the separation column via the second valve and the third valve; and an outlet of the second leaching bottle is in pipeline connection with the upper opening of the separation column via the first valve, the second valve and the third valve in sequence;
an outlet pipeline of the separation column is provided with a second control pump;
the control system is electrically connected to the analysis system, the first valve, the second valve, the third valve, a fourth valve, the first control pump, the second control pump, the heating device and the oscillation device, respectively.

In a specific embodiment of the insoluble substance measurement system of the disclosure, the system further comprises a waste liquid recovery system comprising at least two recovery bottles; an lower outlet of the separation column is connected to the recovery bottles via the second control pump and a fifth valve through an outlet pipeline; and the fifth valve is electrically connected to the control system.

In a specific embodiment of the insoluble substance measurement system of the disclosure, the system further comprises a gas cylinder that is in pipeline connection with the upper opening of the separation column via the fourth valve, a pressure sensor and the third valve in sequence, and the pressure sensor is electrically connected to the control system.

In a specific embodiment of the insoluble substance measurement system of the disclosure, the sample injection tube is arranged in the heating device; the oscillation device is arranged outside the heating device; and the heating device is provided with a first observation window to observe the liquid level in the sample injection tube in real time.

In some embodiments of the disclosure, the oscillation device is arranged outside the heating device and may be directly connected to the heating device.

In a specific embodiment of the insoluble substance measurement system of the disclosure, the sample injection tube is used for bottom injection or port injection, preferably bottom injection.

In a specific embodiment of the insoluble substance measurement system of the disclosure, the sample injection system further comprises a gas replenishing device, and the gas replenishing device is connected to the sample injection tube through a gas injection pipeline. The sample injection system is provided with the gas replenishing device to replenish gas to the sample injection system, which can ensure that the sample injection tube has a positive pressure inside, such that the sample to be measured can be smoothly introduced into the separation column by a pump or the like.

In a specific embodiment of the insoluble substance measurement system of the disclosure, the gas type used in the gas replenishing device provided in the sample injection system includes one or more of nitrogen, air, helium and carbon dioxide, and the flow rate of the gas is 1-100 mL/min. In some preferred embodiments of the disclosure, the gas used in the gas replenishing device provided in the sample injection system is air, even if the gas injection pipeline in the sample injection system is directly connected to the atmosphere.

In a specific embodiment of the insoluble substance measurement system of the disclosure, the frequency of the oscillation device provided in the sample injection system is 1 to 60 times/min.

In a specific embodiment of the insoluble substance measurement system of the disclosure, the separation system comprises at least one separation column, which can realize the separation of insoluble substances in at least one sample to be measured.

In a specific embodiment of the insoluble substance measurement system of the disclosure, the separation system further comprises a heating module; the separation column is arranged in the heating module; and the heating module is provided with a second observation window.

In a specific embodiment of the insoluble substance measurement system of the disclosure, the separation system further comprises a gas replenishing device, and the gas replenishing device is connected to the upper opening of the separation column through a gas injection pipeline. The separation system is provided with the gas replenishing device to replenish gas to the separation column, which can ensure that the upper part of the separation column is an environment with a certain positive pressure and accelerate the solvent elution; and in the stage of drying the separation column, the replenished gas can accelerate the solvent volatilization and shorten the drying time.

In a specific embodiment of the insoluble substance measurement system of the disclosure, the gas type used in the gas replenishing device provided in the separation system includes one or more of air, nitrogen, helium and carbon dioxide, and the flow rate of the gas is 1-100 mL/min.

In a specific embodiment of the insoluble substance measurement system of the disclosure, the separation column comprises a separation tube and filters hermetically provided at both ends of the column body, and the column body is filled with a filler.

In a specific embodiment of the insoluble substance measurement system of the disclosure, the filter comprises a neutral filter paper, a filter cloth, a glass sand core, a polymeric filter or the like, preferably a polymeric filter.

In a specific embodiment of the insoluble substance measurement system of the disclosure, the filter has a pore size of 0.01-400 μm.

In some embodiments of the disclosure, the polymeric filter may be, for example, a polyethylene filter or a Teflon filter.

In a specific embodiment of the insoluble substance measurement system of the disclosure, the filler (i.e., the filter material used in the separation column) has a particle size of 10-400 mesh. Preferably, the particle size of the filler is in gradient distribution, where the particle size of the upper filler is 200-400 mesh, and the particle size of the lower filler is 10-200 mesh.

In a specific embodiment of the insoluble substance measurement system of the disclosure, the filler is a weakly polar material and/or an inert material.

In a specific embodiment of the insoluble substance measurement system of the disclosure, the content of the inert material is 40%-100%, based on 100% of the total weight of the filler.

In a specific embodiment of the insoluble substance measurement system of the disclosure, the filler is quartz sand or a mixture of quartz sand and at least one selected from the group consisting of cellulose, alumina, silica gel, diatomite, clay, polymer, barite powder, and the like; preferably, the content of quartz sand is 80%-100%, based on 100% of the total weight of the filler. In some embodiments of the disclosure, the polymer may be, for example, polytetrafluoroethylene or the like.

In a specific embodiment of the insoluble substance measurement system of the disclosure, the volume of the separation column is 6-150 mL, preferably 20-40 mL.

In a specific embodiment of the insoluble substance measurement system of the disclosure, the leaching system further comprises a heating unit used to heat the first leaching bottle and the second leaching bottle.

In a specific embodiment of the insoluble substance measurement system of the disclosure, the tail ends of the pipelines connected to the first leaching bottle and the second leaching bottle (wherein the end of the pipeline connected to the first leaching bottle and the second leaching bottle is defined as a head end) are respectively provided with spray heads; preferably, the spray heads are shower heads.

In a specific embodiment of the insoluble substance measurement system of the disclosure, the first control pump and the second control pump are peristaltic pumps or plunger pumps.

In a specific embodiment of the insoluble substance measurement system of the disclosure, the control system controls the operation of the system according to a certain procedure by a computer program internally or externally provided on a computer storage medium of the insoluble substance measurement system and completes the determination of the insoluble substance content.

For example, in some embodiments of the disclosure, the control system implements specific actions of a pump control module, a temperature control module, a valve control module, a gas module and an oscillation module to the pumps (the first control pump and the second control pump), the temperature controllers (the heating unit, the heating device, and the heating module), the valves (the first valve to the sixth valve), the pressure gauge (the pressure sensor) switch, and the oscillator (the oscillation device) through a certain program, so as to complete automatic analysis and measurement of the insoluble substance in the sample to be measured.

In another aspect, the disclosure further provides a method for measuring an insoluble substance content implemented by using the insoluble substance measurement system as described above, which comprises the following steps:
(1) adding a sample to be measured and a filler into a sample injection tube and a separation column that are dry, respectively, and then installing the sample injection tube and the separation column into the insoluble substance measurement system;
(2) preheating the sample injection tube and the separation column respectively;
(3) turning on the second control pump such that a first leaching liquid in the first leaching bottle enters the upper opening of the separation column through the first valve, the second valve and the third valve to activate the separation column;
(4) allowing the sample to be measured in the sample injection tube to enter the upper opening of the separation column through the second valve and the third valve by the second control pump at a certain oscillation frequency;
(5) turning on the first control pump to allow the first leaching liquid in the first leaching bottle to enter the sample injection tube; subsequently, allowing the first leaching liquid in the sample injection tube to enter the upper opening of the separation column through the second valve and the third valve by the second control pump at a certain oscillation frequency; repeating the above operations in step (5) to transfer all the samples to be measured in the sample injection tube into the separation column (when the sample to be measured is a sample with a high boiling point, a liquid mixture of the sample to be measured and a solvent is transferred into the separation column herein);
turning on the second control pump such that a second leaching liquid in the second leaching bottle enters the upper opening of the separation column through the first valve, the second valve and the third valve, until the liquid flowing out of the lower end of the separation column is white;
(6) drying the separation column; and
(7) calculating the insoluble substance content according to the mass of the sample to be measured and the mass difference between the separation column in step (6) and the separation column in step (1).

In a specific embodiment of the method of the disclosure, in step (1), the clean sample injection tube and the complete separation column are dried at a temperature of 100-300° C. for 1-5 h and then placed in a desiccator and cooled to room temperature for use.

In a specific embodiment of the method of the disclosure, in step (1), when the sample to be measured is a sample with a high boiling point, the sample to be measured and a solvent are uniformly mixed in a mass ratio of 1:1-1:50 and then added into the sample injection tube; and when the sample to be measured is a liquid sample, the sample to be measured is weighed and then directly added into the sample injection tube.

In the disclosure, the specific substance of the solvent can be reasonably selected according to the actual operation situation on site. For example, in some embodiments of the disclosure, the solvent may be, for example, n-hexane, deionized water, ethanol or the like.

In some embodiments of the disclosure, when the sample to be measured is a sample with a high boiling point, a certain amount of the sample to be measured is weighed and placed into the sample injection tube, and a solvent is added into the sample injection tube; and after the sample is mixed with the solvent, the mixture is uniformly mixed under heating and oscillating conditions.

In a specific embodiment of the method of the disclosure, the amount of the sample to be measured is 0.5-200 g.

In a specific embodiment of the method of the disclosure, in step (2), each of the sample injection tube and the separation column is preheated to 10-300° C., preferably 40-150° C.

In a specific embodiment of the method of the disclosure, in step (3), the feeding speed of the second control pump is 1-50 mL/min, and the addition amount of the first leaching liquid is 0.1-1 times the volume of the separation column.

In a specific embodiment of the method of the disclosure, in step (4), the feeding speed of the second control pump is 1-50 mL/min, and the addition amount of the sample to be measured is 0.1-5 times the volume of the separation column.

In a specific embodiment of the method of the disclosure, in step (4) and step (5), the oscillation is realized by an oscillation device, and the frequency is 1-60 times/min.

In a specific embodiment of the method of the disclosure, in step (5), the feeding speed of the first control pump and the second control pump is 1-50 mL/min, and the addition amount of each of the first leaching liquid and the second leaching liquid is 1-50 times the volume of the separation column.

In the disclosure, specific substances of the first leaching liquid and the second leaching liquid may be reasonably selected according to actual operation conditions on site. For example, in some embodiments of the disclosure, the first leaching liquid may be n-hexane, and the second leaching liquid may be toluene; in some embodiments of the disclosure, the first leaching liquid may be deionized water, ethanol, or the like.

In a specific embodiment of the method of the disclosure, in step (5), the above operations in step (5) are repeated at least twice to clean the sample injection tube and transfer all the samples to be measured in the sample injection tube into the separation column.

In a specific embodiment of the method of the disclosure, the temperature of each of the first leaching liquid and the second leaching liquid is 10-250° C., preferably 40-150° C.

In a specific embodiment of the method of the disclosure, in step (6), the drying comprises opening the fourth valve to allow the gas in the gas cylinder to enter the upper opening of the separation column through a pressure sensor and the third valve and to be discharged from the lower end of the separation column, and drying the separation column while the gas flows through the separation column.

Preferably, the flow rate of the gas is 1-20 mL/min.

In a specific embodiment of the method of the disclosure, the gas in the gas cylinder is an inert gas, preferably, the gas is at least one selected from the group consisting of nitrogen, argon, helium, carbon dioxide, and the like.

In a specific embodiment of the method of the disclosure, in step (6), the drying is to dry the insoluble substances in the separation column at a constant temperature or to dry the insoluble substances in the separation column at a programmed temperature; preferably, the drying is to dry the insoluble substances in the separation column at a constant temperature, that is, the separation column is first heated to a drying temperature and then kept at a constant temperature for a period.

In a specific embodiment of the method of the disclosure, in step (6), the drying is carried out at a temperature of 60-300° C.

In a specific embodiment of the method of the disclosure, in step (7), the insoluble substance content is calculated from the mass of the sample to be measured and the mass difference between the separation column in step (6) and the separation column in step (1) according to the following Equation 1):

$$W = ( {m}_{3} - {m}_{2} ) / {m}_{1} \times 100 \% ; \qquad Equation 1 )$$

in Equation 1):
W is the mass percentage of the insoluble substance in the sample to be measured, in %;
m₁ is the mass of the sample to be measured, in g;
m₂ is the mass of the separation column filled with the filler in step (1), in g;
m₃ is the mass of the separation column after drying in step (6), in g;
wherein, 1−W is the mass percentage of soluble substances in the sample to be measured.

The insoluble substance measurement system and insoluble substance content measurement method provided by the disclosure can be used to determine the content of insoluble substances, such as water insoluble substances, acid and base insoluble substances, and organic solvent insoluble substances, in the sample to be measured, and at least one sample to be measured can be simultaneously analyzed by a new separation method to effectively separate the insoluble substance in the sample to be measured and measure the content of insoluble substances therein. The system and method provided by the disclosure are simple and reliable, have high reproducibility, high analysis efficiency and low solvent consumption, and solve the problems (such as instrument error introduced by the separation consumables, low extraction efficiency/low separation efficiency, blocking filter holes, poor quantitative reliability, long separation time/long time consumption, complicated steps, large solvent consumption and poor separation effect on components with high boiling point) of the traditional method for separating insoluble substances based on Soxhlet extraction, liquid-liquid extraction method, centrifugal separation and the like. In addition, the system provided by the disclosure is provided with a heating device and an oscillation device in the sample injection system and a heating module in the separation system, which can ensure complete and sufficient sample injection, is suitable for separating the insoluble substance in the sample to be measured with a high boiling point, and ensures that the sample to be measured is not condensed.

### BRIEF DESCRIPTION OF DRAWINGS

In order to more clearly illustrate the technical solutions in the embodiments of the disclosure or prior art, the following is a brief description of the accompanying drawings that are required for the description of the embodiments. Obviously, the accompanying drawings in the following description are some embodiments of the disclosure, and other accompanying drawings may be obtained on the basis of these drawings for those of ordinary skill in the art without inventive work.

FIG. 1 is a schematic structural diagram of the insoluble substance measurement system provided in Example 1 of the disclosure.

FIG. 2 is a schematic structural diagram of the sample injection system used in the insoluble substance measurement system provided in Example 1 of the disclosure.

FIG. 3 is a schematic structural diagram of the separation system used in the insoluble substance measurement system provided in Example 1 of the disclosure.

FIG. 4 is a schematic diagram of the electrical connection relationship in the insoluble substance measurement system provided in Example 1 of the disclosure.

### DESCRIPTION OF MAIN REFERENCE NUMERALS

1: first leaching bottle; 2: second leaching bottle; 3: first recovery bottle; 4: second recovery bottle; 5: gas cylinder; 6: fourth valve; 7: pressure sensor; 8: third valve; 9: second valve; 10: first valve; 11: fifth valve; 12: first control pump; 13: second control pump; 14: sample injection tube; 15: separation column; 16: sample injection pipeline; 17: first observation window; 19: liquid injection pipeline; 20: gas injection pipeline; 21: heating device; 22: oscillation device; 23: gas/sample injection pipeline; 24: heating module; 26: second observation window.

### DETAILED DESCRIPTION OF PREFERRED EMBODIMENTS

It should be noted that the term “comprise” and any variations thereof in the description, claims and drawings of the disclosure are intended to cover non-exclusive inclusion, for example, a process, method, system, product or apparatus comprising a series of steps or units is not necessarily limited to those steps or units explicitly listed, but may include other steps or units that are not explicitly listed or are inherent to such process, method, product or apparatus.

In the disclosure, the orientation or positional relationship indicated by the terms “on”, “under”, “inside”, “outside”, “in”, or the like, is based on the orientation or positional relationship shown in the accompanying drawings. These terms are used primarily to better describe the disclosure and examples thereof, and are not intended to define that the indicated device, element, or component must have a particular orientation or be constructed and operated in a particular orientation.

In addition, some of the above terms may be used to denote other meanings in addition to orientation or location relationships. For example, the term “on” may also be used in some instances to indicate a dependency or connection relationship. For those of ordinary skill in the art, the specific meaning of these terms in the disclosure can be understood according to specific circumstances.

In addition, the terms “configure” and “connect” should be understood in a broad sense. For example, a “connection” may refer to a fixed connection, a detachable connection, or an integral construction; or it may be a mechanical connection or an electrical connection; or it may be a direct connection or an indirect connection via an intervening medium; or it may be an internal connection between two devices, elements or components. For those of ordinary skill in the art, the specific meaning of the above terms in the disclosure can be understood according to specific circumstances.

The range disclosed in the disclosure is given in the form of a lower limit and an upper limit. There can be one or more lower limits, and one or more upper limits, respectively. The given range is defined by selecting a lower limit and an upper limit. The selected lower limit and upper limit define the boundary of a particular range. All ranges defined as such are combinable, that is, any lower limit can be combined with any upper limit to form a range. For example, where ranges of 60-120 and 80-110 are listed for a particular parameter, it is understood that the ranges of 60-110 and 80-120 are also contemplated. Furthermore, if the listed minimum values of the range are 1 and 2, and the listed maximum values of the range are 3, 4, and 5, then the following ranges are all contemplated: 1-3, I-4, 1-5, 2-3, 2-4, and 2-5.

In the disclosure, the numerical range “a-b” represents an abbreviation for any combination of real numbers between a and b, wherein a and b are both real numbers, unless specified otherwise. For example, the numerical range “0-5” means that all real numbers among “0-5” have been listed in the disclosure, and “0-5” is just an abbreviation of these numerical combinations.

In the disclosure, all embodiments and preferable embodiments mentioned in the disclosure can be combined with each other to form a new technical solution, unless specified otherwise.

In the disclosure, all technical features and preferable features mentioned in the disclosure can be combined with each other to form a new technical solution, unless specified otherwise.

In order to make the object, technical solutions and advantages of the disclosure clearer, the disclosure will be further described in detail below in conjunction with the drawings and examples. The examples described below are part of examples of the disclosure, not exhaustive, and are only used to illustrate the disclosure, and should not be considered as limiting the scope of the disclosure. All other examples obtained by those skilled in the art on the basis of examples in the disclosure without inventive work are within the protection scope of the present disclosure. If no specific conditions are specified in the examples, it is carried out according to conventional conditions or conditions recommended by the manufacturer. If the manufacturer is not specified for the used reagents or instruments, they are all conventional products that are commercially available.

### Example 1

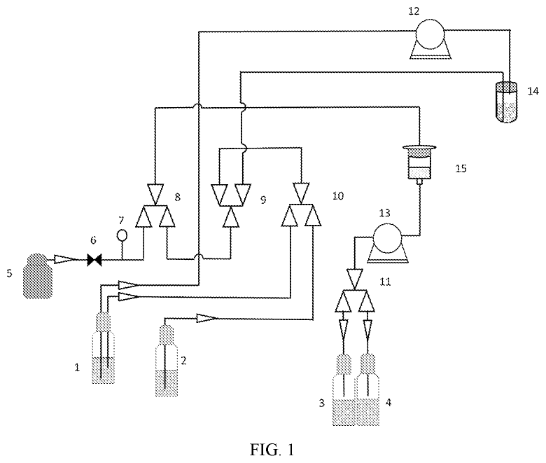

This example provides an insoluble substance measurement system, a schematic structural diagram of which is shown in FIG. 1. As can be seen from FIG. 1, the insoluble substance measurement system comprises:
a box body, and a leaching system, a sample injection system, a separation system, a waste liquid recovery system, an analysis system and a control system that are located in the box body; the leaching system comprises a first leaching bottle 1 and a second leaching bottle 2 and a heating unit for heating the first leaching bottle and the second leaching bottle.

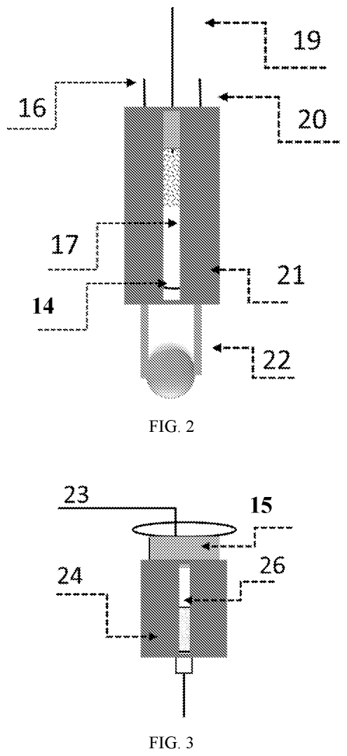

A schematic structural diagram of the sample injection system is shown in FIG. 2. As can be seen from FIG. 2, the sample injection system comprises at least one sample injection tube 14, a heating device 21, an oscillation device 22 and a first gas replenishing device; wherein the sample injection tube 14 is arranged in the heating device 21; the oscillation device 22 is arranged outside the heating device 21; and the heating device 21 is provided with a first observation window 17 to observe the liquid level in the sample injection tube 14 in real time; the sample injection system further comprises a sample injection pipeline 16 for adding a sample to be measured into the sample injection tube 14.

The first gas replenishing device is connected to the sample injection tube 14 through a gas injection pipeline 20.

A schematic structural diagram of the separation system is shown in FIG. 3. As can be seen from FIG. 3, the separation system comprises at least one separation column 15, a heating module 24 for heating the separation column 15, and a second gas replenishing device, where the separation column 15 is arranged in the heating module 24, and the heating module 24 is provided with a second observation window 26; the second gas replenishing device is connected to an upper opening of the separation column 15 through a gas/sample injection pipeline 23; the separation column 15 comprises a separation tube and filters hermetically provided at both ends of the column body, and the column body is filled with a filler.

The waste liquid recovery system comprises at least a first recovery bottle 3 and a second recovery bottle 4.

An outlet of the first leaching bottle 1 is in pipeline connection with the liquid injection pipeline 19 of the sample injection tube 14 via the first control pump 12, and an outlet of the first leaching bottle 1 is further in pipeline connection with an upper opening (gas/sample injection pipeline 23) of the separation column 15 via the first valve 10, the second valve 9 and the third valve 8 in sequence; the sample injection tube 14 is in pipeline connection with the upper opening (gas/sample injection pipeline 23) of the separation column 15 via the second valve 9 and the third valve 8; an outlet of the second leaching bottle 4 is in pipeline connection with the upper opening (gas/sample injection pipeline 23) of the separation column 15 via the first valve 10, the second valve 9 and the third valve 8 in sequence.

The lower opening of the separation column 15 is connected to the first recovery bottle 3 and the second recovery bottle 4 through an outlet pipeline via the second control pump 13 and the fifth valve 11 in sequence.

The gas cylinder 5 is in pipeline connection with the upper opening (gas/sample injection pipeline 23) of the separation column 15 via the fourth valve 6, the pressure sensor 7 and the third valve 8 in sequence.

The control system is electrically connected to the analysis system, the first valve 10, the second valve 9, the third valve 8, the fourth valve 6, the pressure sensor 7, the fifth valve 11, the first control pump 12, the second control pump 13, the heating device 21, the oscillation device 22 and the heating module 24, respectively.

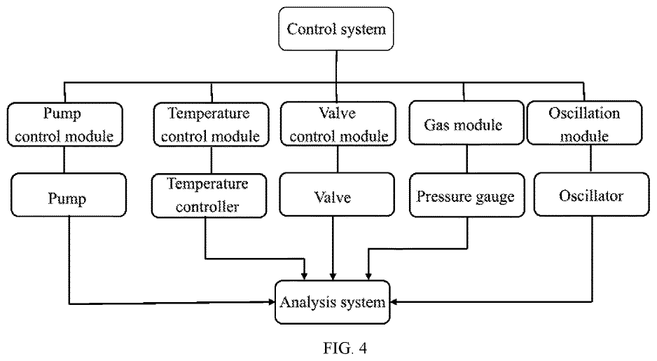

A schematic diagram of the electrical connection relationship in the insoluble substance measurement system is shown in FIG. 4. As can be seen from FIG. 4, the control system implements specific actions of the pump control module, the temperature control module, the valve control module, the gas module, the oscillation module to the pumps (the first control pump and the second control pump), the temperature controllers (the heating unit, the heating device, and the heating module), the valves (the first valve to the sixth valve), the pressure gauge (the pressure sensor) switch, and the oscillator (the oscillation device) according to a program, so as to complete automatic analysis and measurement of the insoluble substance in the sample to be measured.

### Example 2

This example provides a method for separating toluene insoluble substances in a petrochemical asphalt sample and measuring the content thereof, which is implemented by using the insoluble substance measurement system provided in Example 1. Specifically, the method comprises the following steps.

### Step 1. Test Preparation

A clean sample injection tube and a 20 mL separation column filled with a filler were dried at 120° C. for 5 h and then placed in a desiccator, and cooled to room temperature for use.

The filler used in the separation column is a mixture of 1% alumina, 1% silica gel, 1% diatomaceous earth, 1% clay, 1% polytetrafluoroethylene, 1% barite powder, and 94% quartz sand. The particle size of the filler is in gradient distribution, where the particle size of the upper filler is 200-400 mesh, and the particle size of the lower filler is 10-200 mesh.

In the separation column, a neutral filter paper was used as the upper filter and a glass sand core was used as the lower filter, and both the upper filter and the lower filter had a pore size of 40 μm.

### Step 2. Method Preparation

10.0195 g of a petrochemical asphalt sample and n-hexane were diluted at a mass ratio of 1:2, ultrasonically oscillated at 60° C., and uniformly mixed to obtain a uniformly mixed sample solution, which was introduced into the sample injection tube.

The mass of the separation column filled with the filler was weighed.

The sample injection tube and the separation column were mounted in the insoluble substance measurement system.

### Step 3. Preheating the Instrument

The control system was turned on to complete the instrument self-test. At the same time, the temperature of the first leaching bottle, the second leaching bottle and the sample injection tube was maintained at 60° C. by the heating unit and the heating device, and the temperature outside the separation column was maintained at 70° C. by the heating module.

### Step 4. Activating the Separation Column

The second control pump was turned on, such that n-hexane in the first leaching bottle was added into the upper opening of the separation column through the first valve, the second valve and the third valve in sequence, and then entered the first recovery bottle through the fifth valve. Herein, the feeding speed of the second control pump was controlled to be 20 mL/min, and the addition volume of the liquid was controlled to be 10 mL.

### Step 5. Sample Injection

At an oscillation frequency of 10 times/min, the sample solution uniformly mixed at a certain temperature in the sample injection tube was added into the upper opening of the separation column through the second valve and the third valve by the second control pump, and then entered the first recovery bottle through the fifth valve. The feeding speed of the second control pump was controlled to be 20 mL/min, and the addition amount of the uniformly mixed solution sample was controlled to be 30 mL.

### Step 6. Leaching

The first control pump was turned on, such that 30 mL of n-hexane at 60° C. in the first leaching bottle was added into the sample injection tube. Subsequently, the liquid in the sample injection tube was added into the upper opening of the separation column through the second valve and the third valve by the second control pump at an oscillation frequency of 5 times/min, and then entered the first recovery bottle through the fifth valve. Herein, the feeding speed of the first control pump was controlled to be 10 mL/min.

The above process was repeated twice, and all the sample in the sample injection tube was transferred into the separation column.

The second control pump was turned on, such that toluene at 60° C. in the second leaching bottle was added into the upper opening of the separation column through the first valve, the second valve and the third valve, and then entered the second recovery bottle through the fifth valve. The feeding speed of the second control pump was controlled to be 10 mL/min, and the addition amount of toluene was controlled to be 50 mL.

The separation process of the toluene insoluble substance in Steps 2 to 6 took only 15 min.

### Step 7. Drying

The fourth valve was opened, such that the nitrogen in the gas cylinder entered the second recovery bottle through the pressure sensor, the third valve, the separation column, the second control pump and the fifth valve, and then evacuated. Herein, the gas flow rate was 10 mL/min.

The separation column was heated to 120° C. while introducing gas, and dried at a constant temperature for 2 h.

### Step 8. Weighing the Toluene Insoluble Substance

The separation column was removed and placed in a desiccator to cool down to room temperature, and then the mass of the separation column was weighed.

Steps 6 and 7 were repeated once, and then the mass of the separation column was measured until the mass difference between the two separation columns was less than 0.001 g.

### Step 9. Calculation

The insoluble substance content was calculated from the mass of the petrochemical asphalt sample and the mass difference between the separation column in Step 8 and the separation column in Step 2 according to the following Equation 1):

$$W = ( m 3 - m 2 ) / m 1 \times 100 \% ; \qquad Equation 1 )$$

in Equation 1):
W is the mass percentage of the insoluble substance in the sample to be measured, in %;
m₁ is the mass of the sample to be measured, in g;
m₂ is the mass of the separation column filled with the filler in Step 2, in g;
m₃ is the mass of the separation column after drying in Step 8, in g.

In this example, the mass of the sample in the method preparation stage was recorded, that is, m₁ was 10.0195 g; the mass of the separation column, that is, m₂ was 20.4523 g; and the mass of the separation column in the toluene insoluble substance measurement stage, that is, m₃ was 20.5475 g, so the mass of the toluene insoluble substance was 0.0952 g, and the mass percentage of the toluene insoluble substance in the petrochemical asphalt sample was 0.35%.

The measurement of the above sample was repeated once, and the results showed that the mass percentage of toluene insoluble substance in the sample was 0.31%.

It can be seen that the insoluble substance separation process in the method provided by the example of the disclosure is simple and fast, and the whole separation process takes only 15 min, which greatly improves the analysis speed. The reproducibility of the results obtained for the mass percentage of toluene insoluble substance is high with a deviation of only 0.04%.

### Example 3

This example provides a method for measuring the content of water insoluble substance in sodium humate, which is implemented by using the insoluble substance measurement system provided in Example 1. Specifically, the method comprises the following steps.

### Step 1. Test Preparation

A clean sample injection tube and a 150 mL separation column filled with a filler were dried at 300° C. for 1 h and then placed in a desiccator, and cooled to room temperature for use.

The filler used in the separation column is a mixture of 5% of diatomite earth and 95% of quartz sand. The particle size of the filler is in gradient distribution, where the particle size of the upper filler is 200-400 mesh, and the particle size of the lower filler is 10-200 mesh.

In the separation column, a filter cloth was used as the upper filter and a polyethylene sieve plate was used as the lower filter, and both the upper filter and the lower filter had a pore size of 0.01-400 μm.

### Step 2. Method Preparation

0.3455 g of sodium humate was weighed and added into the sample injection tube, and then deionized water was added into the sample injection tube at a mass ratio of 1:50, and the sample was dissolved with heating at 100° C. and oscillation to obtain a uniformly mixed sample solution, which was then introduced into the sample injection tube. Herein, the oscillation frequency was 60 times/min.

The mass of the separation column filled with the filler was weighed.

The sample injection tube and the separation column were mounted in the insoluble substance measurement system.

### Step 3. Preheating the Instrument

The control system was turned on to complete the instrument self-test. After that, the heating system, i.e., the heating unit, the heating module and the heating device, was turned off during the whole process.

### Step 4. Activating the Separation Column

The second control pump was turned on, such that deionized water in the first leaching bottle was added into the upper opening of the separation column through the first valve, the second valve and the third valve, and then entered the first recovery bottle through the fifth valve. Herein, the feeding speed of the second control pump was controlled to be 1 mL/min, and the addition volume of the liquid was controlled to be 15 mL.

### Step 5. Sample Injection

At an oscillation frequency of 20 times/min, the uniformly mixed sample solution at a certain temperature in the sample injection tube was added into the upper opening of the separation column through the second valve and the third valve by the second control pump, and then entered the first recovery bottle through the fifth valve. Herein, the feeding speed of the second control pump was controlled to be 10 mL/min, and the addition amount of the uniformly mixed sample solution was controlled to be 25 mL.

### Step 6. Leaching

The first control pump was turned on, such that 40 mL of deionized water in the first leaching bottle was added into the sample injection tube. Subsequently, the liquid in the sample injection tube was added into the upper opening of the separation column through the second valve and the third valve by the second control pump at an oscillation frequency of 1 time/min, and then entered the first leaching bottle through the fifth valve. Herein, the feeding speed of the first control pump was controlled to be 10 mL/min.

The above process of adding deionized water was repeated, and when 150 mL of water was added, the effluent from the separation column was colorless.

The separation process of the water insoluble substance in Steps 2 to 6 took only 25 min.

### Step 7. Drying

The fourth valve was opened, such that a mixture gas of helium and argon (volume ratio of 1:1) in the gas cylinder entered the second recovery bottle through the pressure sensor, the third valve, the separation column, the second control pump and the fifth valve, and then evacuated. Herein, the gas flow rate was 20 mL/min.

The separation column was heated to 300° C. while introducing gas, and dried at a constant temperature for 0.5 h.

### Step 8. Weighing the Water Insoluble Substance

The separation column was removed and placed in a desiccator to cool down to room temperature, and then the mass of the separation column was weighed.

Steps 6 and 7 were repeated once, and then the mass of the separation column was measured until the mass difference between the two separation columns was less than 0.001 g.

### Step 9. Calculation

The insoluble substance content was calculated from the mass of sodium humate and the mass difference between the separation column in Step 8 and the separation column in Step 2 according to the following Equation 1):

$$W = ( m 3 - m 2 ) / m 1 \times 100 \% ; \qquad Equation 1 )$$

in Equation 1):
W is the mass percentage of the insoluble substance in the sample to be measured, in %;
m₁ is the mass of the sample to be measured, in g;
m₂ is the mass of the separation column filled with the filler in Step 2, in g;
m₃ is the mass of the separation column after drying in Step 8, in g.

In this example, the mass of the sample in the method preparation stage was recorded, that is, m₁ was 0.3455 g; the mass of the separation column, that is, m₂ was 20.3459 g; and the mass of the separation column in the water insoluble substance measurement stage, that is, m₃ was 20.3621 g, so the mass of the water insoluble substance was 0.0162 g, and the mass percentage of the water insoluble substance in the sodium humate was 4.68%.

The measurement of the above sample was repeated once, and the results showed that the mass percentage of water insoluble substance in the sample was 4.61%.

It can be seen that the insoluble substance separation process in the method provided by the example of the disclosure is simple and fast, and the whole separation process takes only 25 min, which greatly improves the analysis speed. The reproducibility of the results obtained for the mass percentage of water insoluble substance is high with a deviation of only 0.07%.

### Example 4

This example provides a method for measuring the content of ethanol insoluble substance when producing polymerized rosin, which is implemented by using the insoluble substance measurement system provided in Example 1. Specifically, the method comprises the following steps.

### Step 1. Test Preparation

A clean sample injection tube and a 50 mL separation column filled with a filler were dried at 100° C. for 3 h and then placed in a desiccator, and cooled to room temperature for use.

The filler used in the separation column is a mixture of 20% of cellulose and 80% of quartz sand. The particle size of the filler is in gradient distribution, where the particle size of the upper filler is 200-400 mesh, and the particle size of the lower filler is 10-200 mesh.

In the separation column, a polyethylene material with a pore size of 50 μm was used as the upper filter, and a Teflon material with a pore size of 0.1 μm was used as the lower filter.

### Step 2. Method Preparation

200 g of a rosin sample was weighed and added into the sample injection tube. Ethanol was then added at a mass ratio of 1:1, and the rosin sample was dissolved with heating at 50° C. and oscillation to obtain a uniformly mixed sample solution, which was introduced into the sample injection tube. Herein, the oscillation frequency was 10 times/min.

The mass of the separation column filled with the filler was weighed.

The sample injection tube and the separation column were mounted in the insoluble substance measurement system.

### Step 3. Preheating the Instrument

The controller was turned on to complete the instrument self-test. At the same time, the temperature of the first leaching bottle, the second leaching bottle and the sample injection tube was controlled at 30° C. by the heating unit and the heating device, and the temperature outside the separation column was controlled at 40° C. by the heating module.

### Step 4. Activating the Separation Column

The second control pump was turned on, such that hot ethanol in the first leaching bottle was added into the upper opening of the separation column through the first valve, the second valve and the third valve, and then entered the first recovery bottle through the fifth valve. Herein, the feeding speed of the second control pump was controlled to be 1 mL/min, and the addition volume of the liquid was controlled to be 50 mL.

### Step 5. Sample Injection

At an oscillation frequency of 10 times/min, the uniformly mixed sample solution at a certain temperature in the sample injection tube was added into the upper opening of the separation column through the second valve and the third valve by the second control pump, and then entered the first recovery bottle through the fifth valve. Herein, the feeding speed of the second control pump was controlled to be 20 mL/min, and the addition amount of the uniformly mixed sample solution was controlled to be 250 mL.

### Step 6. Leaching

The first control pump was turned on, such that 50 mL of hot ethanol in the first leaching bottle was added into the sample injection tube. Subsequently, the liquid in the sample injection tube was added into the upper opening of the separation column through the second valve and the third valve by the second control pump at an oscillation frequency of 5 times/min, and then entered the first recovery bottle through the fifth valve. Herein, the feeding speed of the first control pump was controlled to be 10 mL/min.

The first control pump was turned on, such that 200 mL of hot ethanol in the first leaching bottle was added into the sample injection tube. Subsequently, the liquid in the sample injection tube was added into the upper opening of the separation column through the second valve and the third valve by the second control pump at an oscillation frequency of 10 times/min, and then entered the first recovery bottle through the fifth valve. Herein, the feeding speed of the first control pump was controlled to be 50 mL/min.

The separation process of the ethanol insoluble substance in Steps 2 to 6 took only 30 min.

### Step 7. Drying

The fourth valve was opened, such that carbon dioxide in the gas cylinder entered the second recovery bottle through the pressure sensor, the third valve, the separation column, the second control pump and the fifth valve, and then evacuated. Herein, the gas flow rate was 1 mL/min.

The separation column was heated from 40° C. to 100° C. at a heating rate of 2° C./min and kept for 50 min while introducing gas.

### Step 8. Weighing the Ethanol Insoluble Substance

The separation column was removed and placed in a desiccator to cool down to room temperature, and then the mass of the separation column was weighed.

Steps 6 and 7 were repeated once, and then the mass of the separation column was measured until the mass difference between the two separation columns was less than 0.001 g.

### Step 9. Calculation

The insoluble substance content was calculated from the mass of the rosin sample and the mass difference between the separation column in Step 8 and the separation column in Step 2 according to the following Equation 1):

$$W = ( m 3 - m 2 ) / m 1 \times 100 \% ; \qquad Equation 1 )$$

in Equation 1):
W is the mass percentage of the insoluble substance in the sample to be measured, in %;
m₁ is the mass of the sample to be measured, in g;
m₂ is the mass of the separation column filled with the filler in Step 2, in g;
m₃ is the mass of the separation column after drying in Step 8, in g.

In this example, the mass of the sample in the method preparation stage was recorded, that is, m₁ was 200 g; the mass of the separation column, that is, m₂ was 35.4625 g; and the mass of the separation column in the ethanol insoluble substance measurement stage, that is, m₃ was 35.5025 g, so the mass of the ethanol insoluble substance was 0.0400 g, and the mass percentage of the ethanol insoluble substance in the rosin sample was 0.02%.

The measurement of the above sample was repeated once, and the results showed that the mass percentage of ethanol insoluble substance in the rosin sample was 0.03%.

It can be seen that the insoluble substance separation process in the method provided by the example of the disclosure is simple and fast, and the whole separation process takes only 30 min, which greatly improves the analysis speed. The reproducibility of the results obtained for the mass percentage of ethanol insoluble substance is high with a deviation of only 0.01%.

### Example 5

This example provides a method for separating quinoline insoluble substances in a petrochemical asphalt sample and measuring the content thereof, which is implemented by using the insoluble substance measurement system provided in Example 1. Specifically, the method comprises the following steps.

### Step 1. Test Preparation

A clean sample injection tube and a 6 mL separation column filled with a filler were dried at 130° C. for 1 h and then placed in a desiccator, and cooled to room temperature for use.

Herein, the filler used in the separation column was 100% of quartz sand, and the particle size of the filler was 200-300 mesh.

In the separation column, a neutral filter paper with a pore size of 20 μm was used as the upper filter, and a glass sand core with a pore size of 5 μm was used as the lower filter.

### Step 2. Method Preparation

1 g of a petrochemical asphalt sample and n-heptane were diluted at a mass ratio of 1:15, ultrasonically oscillated at 60° C., and uniformly mixed to obtain a uniformly mixed sample solution, which was introduced into the sample injection tube.

The mass of the separation column filled with the filler was weighed.

The sample injection tube and the separation column were mounted in the insoluble substance measurement system.

### Step 3. Preheating the Instrument

The control system was turned on to complete the instrument self-test. At the same time, the temperature of the first leaching bottle, the second leaching bottle and the sample injection tube was maintained at 80° C. by the heating unit and the heating device, and the temperature outside the separation column was maintained at 90° C. by the heating module.

### Step 4. Activating the Separation Column

The second control pump was turned on, such that quinoline in the first leaching bottle was added into the upper opening of the separation column through the first valve, the second valve and the third valve in sequence, and then entered the first recovery bottle through the fifth valve. Herein, the feeding speed of the second control pump was controlled to be 20 mL/min, and the addition volume of the liquid was controlled to be 6 mL.

### Step 5. Sample Injection

At an oscillation frequency of 10 times/min, the sample solution uniformly mixed at a certain temperature in the sample injection tube was added into the upper opening of the separation column through the second valve and the third valve by the second control pump, and then entered the first recovery bottle through the fifth valve. The feeding speed of the second control pump was controlled to be 20 mL/min, and the addition amount of the uniformly mixed sample solution was controlled to be 25 mL.

### Step 6. Leaching

The first control pump was turned on, such that 50 mL of quinoline at 60° C. in the first leaching bottle was added into the sample injection tube. Subsequently, the liquid in the sample injection tube was added into the upper opening of the separation column through the second valve and the third valve by the second control pump at an oscillation frequency of 5 times/min, and then entered the first recovery bottle through the fifth valve. Herein, the feeding speed of the first control pump was controlled to be 10 mL/min.

The above process was repeated twice, and all the sample in the sample injection tube was transferred into the separation column.

The second control pump was turned on, such that acetone at 60° C. in the second leaching bottle was added into the upper opening of the separation column through the first valve, the second valve and the third valve, and then entered the second recovery bottle through the fifth valve. The feeding speed of the second control pump was controlled to be 10 mL/min, and the addition amount of toluene was controlled to be 150 mL.

The separation process of the quinoline insoluble substance in Steps 2 to 6 took only 40 min.

### Step 7. Drying

The fourth valve was opened, such that the nitrogen in the gas cylinder entered the second recovery bottle through the pressure sensor, the third valve, the separation column, the second control pump and the fifth valve, and then evacuated. Herein, the gas flow rate was 10 mL/min.

The separation column was heated to 120° C. while introducing gas, and dried at a constant temperature for 3 h.

### Step 8. Weighing the Quinoline Insoluble Substance

The separation column was removed and placed in a desiccator to cool down to room temperature, and then the mass of the separation column was weighed.

Steps 6 and 7 were repeated once, and then the mass of the separation column was measured until the mass difference between the two separation columns was less than 0.001 g.

### Step 9. Calculation

The insoluble substance content was calculated from the mass of the petrochemical asphalt sample and the mass difference between the separation column in Step 8 and the separation column in Step 2 according to the following Equation 1):

$$W = ( m 3 - m 2 ) / m 1 \times 100 \% ; \qquad Equation 1 )$$

in Equation 1):
W is the mass percentage of the insoluble substance in the sample to be measured, in %;
m₁ is the mass of the sample to be measured, in g;
m₂ is the mass of the separation column filled with the filler in Step 2, in g;
m₃ is the mass of the separation column after drying in Step 8, in g.

In this example, the mass of the sample in the method preparation stage was recorded, that is, m₁ was 1.2539 g; the mass of the separation column, that is, m₂ was 13.9423 g; and the mass of the separation column in the quinoline insoluble substance measurement stage, that is, m₃ was 13.9625 g, so the mass of the quinoline insoluble substance was 0.0202 g, and the mass percentage of the quinoline insoluble substance in the petrochemical asphalt sample was 1.61%.

The measurement of the above sample was repeated once, and the results showed that the mass percentage of quinoline insoluble substance in the sample was 1.66%.

It can be seen that the insoluble substance separation process in the method provided by the example of the disclosure is simple and fast, and the whole separation process takes only 40 min, which greatly improves the analysis speed. The reproducibility of the results obtained for the mass percentage of quinoline insoluble substance is high with a deviation of only 0.05%.

### Comparative Example 1

In this comparative example, the toluene insoluble substance in the petrochemical asphalt sample provided in Example 2 was separated and measured for its content in accordance with GB/T 2292-2018 “Determination of toluene insoluble content for coking products”. Specifically, the test procedure was as follows.

10 g of treated quartz sand was first poured into a filter paper cylinder, placed in a weighing bottle, and dried in a drying oven at 120° C. to a constant weight. Subsequently, 1 g of the sample was weighed, and the sample and the quartz sand were fully stirred and uniformly mixed in the filter paper cylinder.

A flat-bottomed flask containing 120 mL of toluene was placed in an electric heating mantle. The filter paper cylinder was placed in an extraction cylinder, such that the upper edge of the filter paper cylinder was 20 mm higher than the reflux tube, and then the extraction cylinder was connected to the flat-bottomed flask. After that, about 30 mL of toluene was added along the inner wall of the filter paper cylinder. The condenser hung with drainage iron wire was connected to the extraction cylinder, and cooling water was connected. At the same time, the photoelectric probe of the intelligent counter was horizontally clamped on the reflux tube, and extraction was carried out 60 times. The electric heating mantle was turned on to heat the flat-bottom flask, and the speed of toluene extraction was controlled at 1 min/time to 1.5 min/time. The toluene extract fully flowing back to the flat-bottom flask from the reflux tube is considered as one extraction. When the filter paper cylinder was cleaned by the toluene extract, such that the filter paper cylinder was white or pale yellow and the extract in the extraction cylinder was clarified, this was the end point of extraction. At this time, the heating was stopped, and the power supply of the electric heating mantle was disconnected. The whole extraction process took 180 min.

After the heating was stopped and it was slightly cooled, the filter paper cylinder was removed and placed in the original weighing bottle without capping, which was then placed in a ventilation cabinet. As toluene evaporates, the weighing bottle with the cap was placed in a drying oven at 120° C. for 2 h. After that, the weighing bottle was taken out from the drying oven, immediately capped, placed in a desiccator, cooled to room temperature for weighing, and dried for 0.5 h before constant weight checking, until the mass difference of the dried filter paper cylinder obtained by weighing for 2 consecutive times did not exceed 0.001 g or the mass did not increase any more. The last mass was taken as the basis for calculation; if there was an increase in weight, the mass before the increase was taken as the basis for calculation.

The toluene insoluble substance was measured twice, and the content results were 0.2% and 0.5%, respectively.

Compared with the experimental results in Example 2, it can be seen that in Comparative Example 1, the toluene insoluble substance in the petrochemical asphalt sample provided in Example 2 was separated and measured for the content in accordance with GB/T 2292-2018 “Determination of toluene insoluble content for coking products”, but the steps were complex and it was time-consuming, and the obtained results were poor in reproducibility with a deviation of up to 0.3%.

### Comparative Example 2

In this comparative example, the toluene insoluble substance in the petrochemical asphalt sample provided in Example 2 was separated and measured for its content in accordance with GB/T8926-2012 “Standard test method for insolubles in used lubricating oils”. Specifically, the test procedure was as follows.

A clean centrifuge tube was placed an dried in an oven at 105° C. for 30 min, then cooled in a desiccator and weighed to an accuracy of 1 mg, 10.0 g±0.1 g of the prepared sample was added into the centrifuge tube, and n-pentane was added to the centrifuge tube to a score line of 100 ml, and then the centrifuge tube was plugged with a stopper and shaken until the mixture was well mixed. The stopper was removed, and the insoluble substances on the stopper were rinsed with a minimal amount of n-pentane into the centrifuge tube by using a wash bottle with a spray nozzle. The mass of each pair of centrifuge tubes filled with the sample and the solvent was balanced, and the centrifuge tubes were placed in two symmetrical rotary heads of the centrifuge and centrifuged for 20 min±1 min at a rotation speed of the rotary head of the centrifuge corresponding to a relative centrifugal force of 600-700. The supernatant was decanted without disturbing or dispersing the precipitate, such that the liquid left in the centrifuge tube did not exceed 3 mL.

10 mL±1 mL of n-pentane was added to the centrifuge tube. All insoluble substances at the bottom of the centrifuge tube were broken and loosened with a clean metal wire, and the insoluble substances adhered to the metal wire were rinsed into the centrifuge tube with an appropriate amount of n-pentane until the centrifuge tube was filled to a score line of 50 mL. The centrifuge tube was plugged with a stopper and shaken until the mixture was well mixed. The stopper was removed, and the insoluble substances on the stopper were rinsed with a minimal amount of n-pentane into the centrifuge tube. The mass of each pair of centrifuge tubes was balanced, and the centrifuge tubes were placed in two symmetrical rotary heads of the centrifuge and centrifuged for 20 min±1 min at a rotation speed of the rotary head of the centrifuge corresponding to a relative centrifugal force of 600-700. After centrifugation, the supernatant was carefully decanted to avoid stirring the insoluble substance at the bottom of the centrifuge tube. The above experimental procedure was repeated once to obtain the n-pentane insoluble substance. The whole process took 240 min.

10 mL±1 mL of a toluene-ethanol solution was added to the n-pentane insoluble substance, and all insoluble substances at the bottom of the centrifuge tube were broken and loosened with a clean metal wire, and the insoluble substances adhered to the metal wire were rinsed into the centrifuge tube with an appropriate amount of the toluene-ethanol solution until the centrifuge tube was filled to a score line of 50 mL. The centrifuge tube was plugged with a stopper and shaken until the mixture was well mixed. The stopper was removed, and the insoluble substances on the stopper were rinsed with a minimal amount of toluene into the centrifuge tube. The mass of each pair of centrifuge tubes was balanced, and the centrifuge tubes were placed in two symmetrical rotary heads of the centrifuge and centrifuged for 20 min±1 min at a rotation speed of the rotary head of the centrifuge corresponding to a relative centrifugal force of 600-700, until no visible suspended solid was floating in the solution. The supernatant of the centrifuge tube was carefully decanted to avoid disturbing the precipitates. The above experimental procedure was repeated twice with toluene instead of toluene-ethanol solution.

The centrifuge tube was placed and dried in an oven at 105° C. for 1 h, then cooled in a desiccator and weighed to an accuracy of 1 mg.

The toluene insoluble substance was measured twice, and the content results were 0.25% and 0.43%, respectively.

Compared with the experimental results in Example 2, it can be seen that in Comparative Example 2, the toluene insoluble substance in the petrochemical asphalt sample provided in Example 2 was separated and measured for the content in accordance with GB/T8926-2012 “Standard test method for insolubles in used lubricating oils” after the n-pentane insoluble substance was separated first and then the toluene insoluble substance was separated; it resulted in a large amount of test solvent, complicated steps and time-consuming, and the obtained results of the mass percent content of toluene insoluble substance was poor in reproducibility with a deviation of up to 0.18%.

### Comparative Example 3

In this comparative example, the filler used in the separation column was changed, and the toluene insoluble content of a petrochemical asphalt sample in Example 2 was measured by using the steps described in Example 2. Specifically, the method comprises the following steps:

### Step 1. Test Preparation

A clean sample injection tube and a 20 mL separation column filled with a filler were dried at 120° C. for 5 h and then placed in a desiccator, and cooled to room temperature for use.

Herein, the filler used in the separation column was an alumina stationary phase with a silver nitrate loading of 5.2 wt %, and the particle size of the filler was 100-200 mesh.

In the separation column, a neutral filter paper was used as the upper filter, and a glass sand core was used as the lower filter, and both of them had a pore size of 0.01-400 μm.

### Step 2. Method Preparation

The petrochemical asphalt sample and n-hexane were diluted at a mass ratio of 1:2, ultrasonically oscillated at 60° C., and uniformly mixed to obtain a uniformly mixed sample solution, which was introduced into the sample injection tube.

The mass of the separation column filled with the filler was weighed.

The sample injection tube and the separation column were mounted in the insoluble substance measurement system.

### Step 3. Preheating the Instrument

The control system was turned on to complete the instrument self-test. At the same time, the temperature of the first leaching bottle, the second leaching bottle and the sample injection tube was maintained at 60° C. by the heating unit and the heating device, and the temperature outside the separation column was maintained at 70° C. by the heating module.

### Step 4. Activating the Separation Column

The second control pump was turned on, such that n-hexane in the first leaching bottle was added into the upper opening of the separation column through the first valve, the second valve and the third valve in sequence, and then entered the first recovery bottle through the fifth valve. Herein, the feeding speed of the second control pump was controlled to be 20 mL/min, and the addition volume of the liquid was controlled to be 30 mL.

### Step 5. Sample Injection

At an oscillation frequency of 10 times/min, the sample solution uniformly mixed at a certain temperature in the sample injection tube was added into the upper opening of the separation column through the second valve and the third valve by the second control pump, and then entered the first recovery bottle through the fifth valve. The feeding speed of the second control pump was controlled to be 20 mL/min, and the addition amount of the uniformly mixed sample solution was controlled to be 500 mL.

### Step 6. Leaching

The first control pump was turned on, such that 30 mL of n-hexane at 60° C. in the first leaching bottle was added into the sample injection tube. Subsequently, the liquid in the sample injection tube was added into the upper opening of the separation column through the second valve and the third valve by the second control pump at an oscillation frequency of 5 times/min, and then entered the first recovery bottle through the fifth valve. Herein, the feeding speed of the first control pump was controlled to be 10 mL/min.

The above process was repeated twice, and all the sample in the sample injection tube was transferred into the separation column.

The second control pump was turned on, such that toluene at 60° C. in the second leaching bottle was added into the upper opening of the separation column through the first valve, the second valve and the third valve, and then entered the second recovery bottle through the fifth valve. The feeding speed of the second control pump was controlled to be 1 mL/min, and the addition amount of toluene was controlled to be 50 mL.

The separation process of the toluene insoluble substance in Steps 2 to 6 took only 15 min.

### Step 7. Drying

The fourth valve was opened, such that the nitrogen in the gas cylinder entered the second recovery bottle through the pressure sensor, the third valve, the separation column, the second control pump and the fifth valve, and then evacuated. Herein, the gas flow rate was 10 mL/min.

The separation column was heated to 120° C. while introducing gas, and dried at a constant temperature for 2 h.

### Step 8. Weighing the Toluene Insoluble Substance

The separation column was removed and placed in a desiccator to cool down to room temperature, and then the mass of the separation column was weighed.

Steps 6 and 7 were repeated once, and then the mass of the separation column was measured until the mass difference between the two separation columns was less than 0.001 g.

### Step 9. Calculation

The insoluble substance content was calculated from the mass of the petrochemical asphalt sample and the mass difference between the separation column in Step 8 and the separation column in Step 2 according to the following Equation 1):

$$W = ( m 3 - m 2 ) / m 1 \times 100 \% ; \qquad Equation 1 )$$

in Equation 1):
W is the mass percentage of the insoluble substance in the sample to be measured, in %;
m1 is the mass of the sample to be measured, in g;
m2 is the mass of the separation column filled with the filler in Step 2, in g;
m3 is the mass of the separation column after drying in Step 8, in g.

In this example, the mass of the sample in the method preparation stage was recorded, that is, m1 was 10.2451 g; the mass of the separation column, that is, m2 was 20.5634 g; and the mass of the separation column in the toluene insoluble substance measurement stage, that is, m3 was 21.1115 g, so the mass of the toluene insoluble substance was 0.5481 g, and the mass percentage of the toluene insoluble substance in the petrochemical asphalt sample was 5.35%.

It can be seen that compared with Example 2, in this comparative example, the toluene insoluble substance content of the petrochemical asphalt sample was determined by using the conventional solid phase extraction method; a high residual amount of the insoluble substance on the stationary phase resulted in a large error in the obtained mass percentage result of toluene insoluble substance, that is, the conventional solid phase extraction method used in this comparative example could not be used for the analysis of toluene insoluble substance and the like.

### Comparative Example 4

In this comparative example, the insoluble substance content in the petrochemical asphalt sample in Example 2 was measured by using the method disclosed in Chinese patent CN 106947515A. Specifically, the method comprises the following steps.

First, an alumina stationary phase with a loading of silver salt was prepared. The alumina was dried at 400° C. for 5 h to obtain activated alumina. 5.0 g of silver nitrate was dissolved in 60 mL of deionized water to prepare a solution, and 95 g of the activated alumina was weighed and the prepared silver nitrate aqueous solution was added into the alumina under stirring, until the completion of the addition to just reach the saturated water absorption of the alumina. Stirring was further continued for 15 min. The alumina impregnated with silver nitrate was allowed to stand for 12 h, and then dried at 150° C. for 5 h to obtain an alumina stationary phase with a loading of silver nitrate. The content of silver nitrate calculated on basis of alumina was 5.2% by mass.

0.4354 g of the petrochemical asphalt sample was dissolved in 1.5 mL of n-hexane. 7 g of the stationary phase prepared as above was filled into a solid phase extraction column, and the mass of the solid phase extraction column was weighed to be 8.3541 g. The stationary phase was wetted with 2 mL of n-hexane, and the n-hexane solution of the petrochemical asphalt sample was added to the solid phase extraction column. The solid phase extraction column was installed on a solid phase extraction device with a vacuum system, and the stationary phase was rinsed with 9 mL of n-hexane to obtain a leaching liquid containing saturated hydrocarbon components. Subsequently, the stationary phase was rinsed with 5 mL of dichloromethane to obtain a leaching liquid containing aromatic hydrocarbon components. Subsequently, the stationary phase was rinsed with 5 mL of a mixed solution of dichloromethane and ethanol at an equivalent volume ratio to obtain a leaching liquid containing colloidal components. Subsequently, the extraction column was rinsed with 5 mL of quinoline, and the quinoline insoluble substance remained on the extraction column.

The rinsing solvent in the obtained leaching liquid was evaporated to obtain 0.2336 g of saturated hydrocarbon, 0.1701 g of aromatic hydrocarbon and 0.0451 g of colloid. The total recovery rate was 103.1% by mass, which satisfied the requirements of the method. Finally, the extraction column was dried at a constant temperature of 120° C. for 2 h to obtain an extraction column mass of 8.3512 g, and thus the obtained mass of the insoluble substance was-0.0029 g, which was abnormal. Possibly because the low addition amount of the sample caused an inaccurate measurement, resulting in an error of result.

It can be seen that when the insoluble substance content in the petrochemical asphalt sample in Example 2 was measured by using the method as described in Comparative Example 4, that is, the method disclosed in Chinese patent CN 106947515A, the sample throughput is low, and the insoluble substance content could not be effectively determined.

In summary, the insoluble substance measurement system and insoluble substance content measurement method provided in Examples of the disclosure can be used to determine the content of insoluble substances such as water insoluble substances, acid and base insoluble substances and organic solvent insoluble substances in the sample to be measured, and at least one sample to be measured can be simultaneously analyzed by a new separation method to effectively separate the insoluble substances in the sample to be measured and measure the content of insoluble substances therein. The system and method provided by the disclosure are simple and reliable, have high reproducibility, high analysis efficiency and low solvent consumption, and solve the problems (such as instrument error introduced by the separation consumables, low extraction efficiency/low separation efficiency, blocking filter holes, poor quantitative reliability, long separation time/long time consumption, complicated steps, large solvent consumption and poor separation effect on components with high boiling point) of the traditional techniques for separating insoluble substances based on Soxhlet extraction, liquid-liquid extraction method, centrifugal separation and the like. In addition, the system provided in Examples of the disclosure is provided with a heating device and an oscillation device in the sample injection system and a heating module in the separation system, which can ensure complete and sufficient sample injection, is suitable for separating the insoluble substance in the sample to be measured with a high boiling point, and ensures that the sample to be measured is not condensed.

The above description is only specific examples of the disclosure, and cannot limit the implementable scope of the disclosure, so the replacement with its equivalent component, or the equivalent changes and modifications made according to the protection scope of the present patent for invention, should still fall within the scope of this patent. In addition, a technical feature and another technical feature, a technical feature and a technical invention, and a technical invention and another technical invention in the disclosure can be used in any arbitrary combination.

1. An insoluble substance measurement system, comprising:
a box body, and a leaching system, a sample injection system, a separation system, an analysis system and a control system that are located in the box body, wherein the leaching system comprises a first leaching bottle and a second leaching bottle; the sample injection system comprises at least one sample injection tube, a heating device and an oscillation device; and the separation system comprises at least one separation column;
wherein an outlet of the first leaching bottle is in pipeline connection with the sample injection tube via a first control pump, and an outlet of the first leaching bottle is further in pipeline connection with an upper opening of the separation column via a first valve, a second valve and a third valve in sequence; the sample injection tube is in pipeline connection with the upper opening of the separation column via the second valve and the third valve; and an outlet of the second leaching bottle is in pipeline connection with the upper opening of the separation column via the first valve, the second valve and the third valve in sequence;
an outlet pipeline of the separation column is provided with a second control pump;
the control system is electrically connected to each of the analysis system, the first valve, the second valve, the third valve, a fourth valve, the first control pump, the second control pump, the heating device and the oscillation device.

2. The insoluble substance measurement system according to claim 1, wherein the system further comprises a waste liquid recovery system comprising at least two recovery bottles; a lower outlet of the separation column is connected to the recovery bottles via the second control pump and a fifth valve through an outlet pipeline; and the fifth valve is electrically connected to the control system.

3. The insoluble substance measurement system according to claim 1, wherein the system further comprises a gas cylinder that is in pipeline connection with the upper opening of the separation column via the fourth valve, a pressure sensor and the third valve in sequence, and the pressure sensor is electrically connected to the control system.

4. The insoluble substance measurement system according to claim 1, wherein the sample injection tube is arranged in the heating device; the oscillation device is arranged outside the heating device; and the heating device is provided with a first observation window to observe the liquid level in the sample injection tube in real time.

5. (canceled)

6. The insoluble substance measurement system according to claim 1, wherein the separation system further comprises a heating module; the separation column is arranged in the heating module; and the heating module is provided with a second observation window;
wherein the separation system further comprises a gas replenishing device, and the gas replenishing device is connected to the upper opening of the separation column through a gas injection pipeline.

7. (canceled)

8. The insoluble substance measurement system according to claim 1, wherein the separation column comprises a separation tube and filters hermetically provided at both ends of the column body, and the column body is filled with a filler.

9. The insoluble substance measurement system according to claim 8, wherein the filter comprises a neutral filter paper, a filter cloth, a glass sand core or a polymeric filter.

10. (canceled)

11. The insoluble substance measurement system according to claim 8, wherein the filler has a particle size of 10-400 mesh.

12. The insoluble substance measurement system according to claim 11, wherein the particle size of the filler is in gradient distribution, where the particle size of the upper filler is 200-400 mesh, and the particle size of the lower filler is 10-200 mesh.

13. The insoluble substance measurement system according to claim 8, wherein the filler is a weakly polar material and/or an inert material.

14. The insoluble substance measurement system according to claim 13, wherein the content of the inert material is 40%-100%, based on 100% of the total weight of the filler.

15. The insoluble substance measurement system according to claim 13, wherein the filler is quartz sand or a mixture of quartz sand and at least one selected from the group consisting of cellulose, alumina, silica gel, diatomite, clay, polymer and barite powder.

16. (canceled)

17. The insoluble substance measurement system according to claim 1, wherein the volume of the separation column is 6-150 mL.

18. (canceled)

19. A method for measuring an insoluble substance content implemented by using the insoluble substance measurement system according to claim 1, comprising:
(1) adding a sample to be measured and a filler into a sample injection tube and a separation column that are dry, respectively, and then installing the sample injection tube and the separation column into the insoluble substance measurement system;
(2) preheating the sample injection tube and the separation column respectively;
(3) turning on the second control pump such that a first leaching liquid in the first leaching bottle enters the upper opening of the separation column through the first valve, the second valve and the third valve to activate the separation column;
(4) allowing the sample to be measured in the sample injection tube to enter the upper opening of the separation column through the second valve and the third valve by the second control pump at a certain oscillation frequency;
(5) turning on the first control pump to allow the first leaching liquid in the first leaching bottle to enter the sample injection tube; subsequently, allowing the first leaching liquid in the sample injection tube to enter the upper opening of the separation column through the second valve and the third valve by the second control pump at a certain oscillation frequency; repeating the above operations in (5) to transfer all the samples to be measured in the sample injection tube into the separation column;
turning on the second control pump such that a second leaching liquid in the second leaching bottle enters the upper opening of the separation column through the first valve, the second valve and the third valve, until the liquid flowing out of the lower end of the separation column is white;
(6) drying the separation column; and
(7) calculating the insoluble substance content according to the mass of the sample to be measured and the mass difference between the separation column in (6) and the separation column in (1).

20. The method according to claim 19, wherein in (1), when the sample to be measured is a sample with a high boiling point, the sample to be measured and a solvent are uniformly mixed in a mass ratio of 1:1-1:50 and then added into the sample injection tube; and when the sample to be measured is a liquid sample, the sample to be measured is weighed and then directly added into the sample injection tube.

21. The method according to claim 19, wherein in (2), the sample injection tube and the separation column are preheated to 10-300° C., respectively.

22. (canceled)

23. The method according to claim 19, wherein in (3), the feeding speed of the second control pump is 1-50 mL/min, and the addition amount of the first leaching liquid is 0.1-1 times the volume of the separation column;
wherein in (4), the feeding speed of the second control pump is 1-50 mL/min, and the addition amount of the sample to be measured is 0.1-5 times the volume of the separation column;
wherein in (5), the feeding speed of the first control pump and the second control pump is 1-50 mL/min, and the addition amount of each of the first leaching liquid and the second leaching liquid is 1-50 times the volume of the separation column.

24. (canceled)

25. (canceled)

26. The method according to claim 19, wherein the temperature of each of the first leaching liquid and the second leaching liquid is 10-250° C.

27. (canceled)

28. The method according to claim 19, wherein in (6), the drying comprises opening the fourth valve to allow the gas in the gas cylinder to enter the upper opening of the separation column through a pressure sensor and the third valve and to be discharged from the lower end of the separation column, and drying the separation column while the gas flows through the separation column;
wherein the flow rate of the gas is 1-20 mL/min, and the drying is carried out at a temperature of 60-300° C.

29. (canceled)

30. (canceled)

31. The method according to claim 19, wherein in (7), the insoluble substance content is calculated from the mass of the sample to be measured and the mass difference between the separation column in (6) and the separation column in (1) according to the following Equation 1):
$$W = ( {m}_{3} - {m}_{2} ) / {m}_{1} \times 100 \% ; \qquad Equation 1 )$$
in Equation 1):
W is the mass percentage of the insoluble substance in the sample to be measured, in %;
m₁ is the mass of the sample to be measured, in g;
m₂ is the mass of the separation column filled with the filler in (1), in g;
m₃ is the mass of the separation column after drying in (6), in g.
